(19) United States
(12) Patent Application Publication
(10) Pub. No.: US 2006/0008006 A1
(43) Pub. Date: Jan. 12, 2006

(54) Video encoding and decoding methods and video encoder and decoder

(75) Inventors: Sang-chang Cha, Hwaseong-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/174,633

(22) Filed: Jul. 6, 2005

Related U.S. Application Data
(60) Provisional application No. 60/585,604, filed on Jul. 7, 2004.

(30) Foreign Application Priority Data
Jul. 15, 2004 (KR) 10-2004-0055283

(51) Int. Cl. H04B 1/66; H04N 11/02; H04N 11/04; H04N 7/12

(52) U.S. Cl. 375/240.16; 375/240.12; 375/240.24; 375/240.03

(57) ABSTRACT

Video coding and decoding methods and video encoder and decoder are provided. The video encoding method includes determining one of inter predictive coding and intra predictive coding mode as a coding mode for each block in an input video frame, generating a predicted frame for the input video frame based on predicted blocks obtained according to the determined coding mode, and encoding the input video frame based on the predicted frame. When the intra predictive coding mode is determined as the coding mode, an intra basis block composed of representative values of a block is generated for a block and the intra basis block is interpolated to generate an intra predicted block for the block.

### CROSS-REFERENCE TO RELATED APPLICATIONS

This application claims priority from Korean Patent Application No. 10-2004-0055283 filed on Jul. 15, 2004 in the Korean Intellectual Property Office, and U.S. Provisional Patent Application No. 60/585,604 filed on Jul. 7, 2004 in the United States Patent and Trademark Office, the disclosures of which are incorporated herein by reference in their entirety.

### BACKGROUND OF THE INVENTION

1. Field of the Invention

Apparatuses and methods consistent with the present invention relate to a video coding algorithm, and more particularly, to scalable video encoding and decoding capable of supporting an intra predictive coding mode.

2. Description of the Related Art

With the development of information communication technology including the Internet, video communication as well as text and voice communication has rapidly increased. Conventional text communication cannot satisfy various user demands, and thus multimedia services that can provide various types of information such as text, pictures, and music have increased. Multimedia data requires a large capacity of storage media and a wide bandwidth for transmission since the amount of multimedia data is usually large in relative terms to other types of data. Accordingly, a compression coding method is required for transmitting multimedia data including text, video, and audio. For example, a 24-bit true color image having a resolution of 640*480 needs a capacity of 640*480*24 bits, i.e., data of about 7.37 Mbits, per frame. When an image such as this is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting multimedia data including text, video, and audio.

In such a compression coding method, a basic principle of data compression lies in removing data redundancy. Data redundancy is typically defined as: (i) spatial redundancy in which the same color or object is repeated in an image; (ii) temporal redundancy in which there is little change between adjacent frames in a moving image or the same sound is repeated in audio; or (iii) mental visual redundancy taking into account human eyesight and perception dull to high frequency. Data can be compressed by removing such data redundancy. Data compression can largely be classified into lossy/lossless compression, according to whether source data is lost, intraframe/interframe compression, according to whether individual frames are compressed independently, and symmetric/asymmetric compression, according to whether a time required for compression is the same as a time required for recovery. In addition, data compression is defined as real-time compression when a compression/recovery time delay does not exceed 50 ms and as scalable compression when frames have different resolutions. As examples, for text or medical data, lossless compression is usually used. For multimedia data, lossy compression is usually used. Meanwhile, intraframe compression is usually used to remove spatial redundancy, and interframe compression is usually used to remove temporal redundancy.

Transmission performance is different depending on transmission media. Currently used transmission media have various transmission rates. For example, an ultra high-speed communication network can transmit data of several tens of megabits per second while a mobile communication network has a transmission rate of 384 kilobits per second. In related art video coding methods such as Motion Picture Experts Group (MPEG)-1, MPEG-2, H.263, and H.264, temporal redundancy is removed by motion compensation based on motion estimation and compensation, and spatial redundancy is removed by transform coding. These methods have satisfactory compression rates, but they do not have the flexibility of a truly scalable bitstream since they use a reflexive approach in a main algorithm. Accordingly, to support transmission media having various speeds or to transmit multimedia at a data rate suitable to a transmission environment, data coding methods having scalability, such as wavelet video coding and subband video coding, may be suitable to a multimedia environment. Scalability indicates the ability to partially decode a single compressed bitstream, that is, the ability to perform a variety of types of video reproduction. Scalability includes spatial scalability indicating a video resolution, signal-to noise ratio (SNR) scalability indicating a video quality level, temporal scalability indicating a frame rate, and a combination thereof.

Among many techniques used for wavelet-based scalable video coding, motion compensated temporal filtering (MCTF) that was introduced by Ohm and improved by Choi and Wood is an essential technique for removing temporal redundancy and for video coding having flexible temporal scalability. In MCTF, coding is performed on a group of pictures (GOPs).

FIG. 1 is a block diagram of an MCTF-based scalable video encoder, and FIG. 2 illustrates a temporal filtering process in conventional MCTF-based video coding.

Referring to FIG. 1, a scalable video encoder includes a motion estimator 110 estimating motion between input video frames and determining motion vectors, a motion compensated temporal filter 140 compensating the motion of an interframe using the motion vectors and removing temporal redundancies within the interframe subjected to motion compensation, a spatial transformer 150 removing spatial redundancies within an intraframe and the interframe within which the temporal redundancies have been removed and producing transform coefficients, a quantizer 160 quantizing the transform coefficients in order to reduce the amount of data, a motion vector encoder 120 encoding a motion vector in order to reduce bits required for the motion vector, and a bitstream generator 130 using the quantized transform coefficients and the encoded motion vectors to generate a bitstream.

The motion estimator 110 calculates a motion vector to be used in compensating the motion of a current frame and removing temporal redundancies within the current frame. The motion vector is defined as a displacement from the best-matching block in a reference frame with respect to a block in a current frame. In a Hierarchical Variable Size Block Matching (HVSBM) algorithm, one of various known motion estimation algorithms, a frame having an N*N resolution is first downsampled to form frames with lower resolutions such as N/2*N/2 and N/4*N/4 resolutions. Then, a motion vector is obtained at the N/4*N/4 resolution and a motion vector having N/2*N/2 resolution is obtained using the N/4*N/4 resolution motion vector. Similarly, a motion vector with N*N resolution is obtained using the N/2*N/2 resolution motion vector. After obtaining the motion vectors at each resolution, the final block size and the final motion vector are determined through a selection process.

The motion compensated temporal filter 140 removes temporal redundancies within a current frame using the motion vectors obtained by the motion estimator 110. To accomplish this, the motion compensated temporal filter 140 uses a reference frame and motion vectors to generate a predicted frame and compares the current frame with the predicted frame to thereby generate a residual frame. The temporal filtering process will be described in more detail later with reference to FIG. 2.

The spatial transformer 150 spatially transforms the residual frames to obtain transform coefficients. The video encoder removes spatial redundancies within the residual frames using wavelet transform. The wavelet transform is used to generate a spatially scalable bitstream.

The quantizer 160 uses an embedded quantization algorithm to quantize the transform coefficients obtained through the spatial transformer 150. Embedded quantization algorithms currently known are Embedded Zerotree Wavelet (EZW), Set Partitioning in Hierarchical Trees (SPIHT), Embedded Zero Block Coding (EZBC), and Embedded Block Coding with Optimized Truncation (EBCOT). In this exemplary embodiment, any one among the known embedded quantization algorithms may be used. Embedded quantization is used to generate bitstreams having SNR scalability.

The motion vector encoder 120 encodes the motion vectors calculated by the motion estimator 110.

The bitstream generator 130 generates a bitstream containing the quantized transform coefficients and the encoded motion vectors.

An MCTF algorithm will now be described with reference to FIG. 2.

For convenience of explanation, a group of picture (GOP) size is assumed to be 16. First, in temporal level 0, a scalable video encoder receives 16 frames and performs MCTF forward with respect to the 16 frames, thereby obtaining 8 low-pass frames and 8 high-pass frames. Then, in temporal level 1, MCTF is performed forward with respect to the 8 low-pass frames, thereby obtaining 4 low-pass frames and 4 high-pass frames. In temporal level 2, MCTF is performed forward with respect to the 4 low-pass frames obtained in temporal level 1, thereby obtaining 2 low-pass frames and 2 high-pass frames. Lastly, in temporal level 3, MCTF is performed forward with respect to the 2 low-pass frames obtained in temporal level 2, thereby obtaining 1 low-pass frame and 1 high-pass frame.

A process of performing MCTF on two frames and thereby obtaining a single low-pass frame and a single high-pass frame will now be described. The video encoder predicts motion between the two frames, generates a predicted frame by compensating the motion, compares the predicted frame with one frame to thereby generate a high-pass frame, and calculates the average of the predicted frame and the other frame to thereby generate a low-pass frame. As a result of MCTF, a total of 16 subbands H1, H3, H5, H7, H9, H11, H13, H15, LH2, LH6, LH10, LH14, LLH4, LLH12, LLLH8, and LLLL16 including 15 high-pass subbands and 1 low-pass subband at the last level are obtained.

Since the low-pass frame obtained at the last level is an approximation of the original frame, it is possible to generate a bitstream having temporal scalability. That is, when the bitstream is truncated in such a way as to transmit only the frame LLLL16 to a decoder, the decoder decodes the frame LLLL16 to reconstruct a video sequence with a frame rate that is one sixteenth of the frame rate of the original video sequence. When the bitstream is truncated in such a way as to transmit frames LLLL16 and LLLH8 to the decoder, the decoder decodes the frames LLLL16 and LLLH8 to reconstruct a video sequence with a frame rate that is one eighth of the frame rate of the original video sequence. In a similar fashion, the decoder reconstructs video sequences with a quarter frame rate, a half frame rate, and a full frame rate from a single bitstream.

Since scalable video coding allows the decoder to generate video sequences at various resolutions, various frames rates or various qualities from a single bitstream, this technique can be used in a wide variety of applications. However, currently known scalable video coding schemes offer significantly lower compression efficiency than other existing coding schemes such as H.264. Since the low compression efficiency is an important factor that severely impedes the wide use of scalable video coding, various attempts are being made to improve compression efficiency for scalable video coding. One of the various approaches is to introduce an intra predictive coding mode into an MCTF process.

However, when introducing the intra predictive coding mode to an MCTF process in scalable video coding based on wavelet transform, an error may tend to occur at a boundary between an intra-predicted block and an inter-predicted block.

Therefore, to improve efficiency of scalable video coding, there is a need to incorporate an intra predictive coding mode designed to reduce the error at a boundary between an intra-predicted block and an inter-predicted block.

### SUMMARY OF THE INVENTION

The present invention provides scalable video encoding and decoding methods capable of supporting an intra predictive coding mode and a scalable video encoder and a scalable video decoder.

According to an aspect of the present invention, there is provided a video encoding method including: determining one of inter predictive coding and intra predictive coding modes as a coding mode for each block in an input video frame; generating a predicted frame for the input video frame using predicted blocks obtained according to the determined coding mode; and encoding the input video frame using the predicted frame. When the intra predictive coding mode is determined as the coding mode, an intra basis block composed of representative values of a block is generated for a block and the intra basis block is interpolated to generate an intra predicted block for the block.

According to another aspect of the present invention, there is provided a video encoder including a mode determiner determining one of an inter predictive coding mode and an intra predictive coding mode as a coding mode for each block in an input video frame and generating predicted blocks according to the determined mode, a temporal filter generating a predicted frame for the input video frame using the predicted blocks and removing temporal redundancies within the video frame using the predicted frame, a spatial transformer removing spatial redundancies within the video frame in which the temporal redundancies have been removed, a quantizer quantizing the video frame in which the spatial redundancies have been removed, and a bitstream generator generating a bitstream containing the quantized video frame, wherein the mode determiner generates an intra basis block composed of representative values for a block for which an intra predictive coding mode is determined and then generates an intra predicted block for the block by interpolating the intra basis block.

According to still another aspect of the present invention, there is provided a video decoding method including interpreting an input bitstream and obtaining texture information, motion vector information, and intra basis block information, generating a predicted frame using the texture information, the motion vector information, and the intra basis block information, and reconstructing a video frame using the predicted frame, wherein an intra predicted block in the predicted frame is obtained by adding residual block information contained in the texture information to intra predicted block information obtained by interpolating the intra basis block information.

According to a further aspect of the present invention, there is provided a video decoder including a bitstream interpreter interpreting a bitstream and obtaining texture information, motion vector information, and intra basis block information, an inverse quantizer inversely quantizing the texture information, an inverse spatial transformer performing inverse spatial transform on the inversely quantized texture information and generating a residual frame, and an inverse temporal filter generating a predicted frame using the residual frame, the motion vector information, and the intra basis block information and reconstructing a video frame using the predicted frame, wherein the inverse temporal filter generates an intra predicted block in the predicted frame by adding residual block information contained in the residual frame to intra predicted block information obtained by interpolating the intra basis block information.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a conventional scalable video encoder;

FIG. 2 illustrates a temporal filtering process in conventional scalable video coding;

FIG. 3 is a block diagram of a video encoder according to an exemplary embodiment of the present invention;

FIG. 4 is a diagram for explaining a process of generating an intra basis block according to an exemplary embodiment of the present invention;

FIG. 5 is a diagram for explaining a process of generating an intra predicted block according to an exemplary embodiment of the present invention;

FIG. 6 is a diagram for explaining a process of filtering a predicted frame according to an exemplary embodiment of the present invention;

FIG. 7 illustrates the process of an intra predictive coding mode according to an exemplary embodiment of the present invention;

FIG. 8 illustrates the process of an intra predictive coding mode according another exemplary embodiment of the present invention; and

FIG. 9 is a block diagram of a video decoder according to an exemplary embodiment of the present invention.

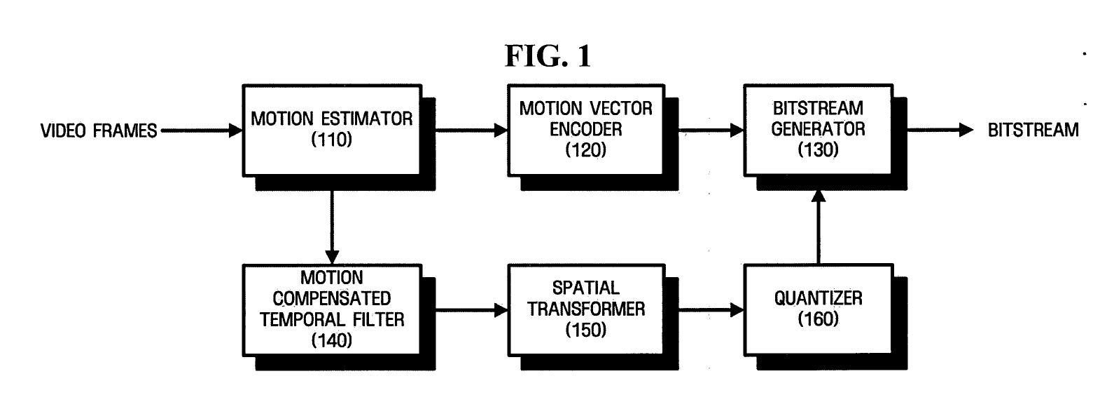

### DETAILED DESCRIPTION OF EXEMPLARY EMBODIMENTS OF THE INVENTION

The present invention will now be described more fully with reference to the accompanying drawings, in which exemplary embodiments of this invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims.

Video coding algorithms according to exemplary embodiments of the present invention employ intra prediction and frame filtering techniques to improve coding efficiency and image quality, respectively. Intra prediction can be used for scalable video coding algorithms as well as discrete cosine transform (DCT)-based video coding algorithms. The intra prediction and the frame filtering can be performed independently or together. Hereinafter, the present invention will be described with reference to exemplary embodiments in which scalable video coding uses intra-prediction and frame filtering together. Thus, some components may be optional or can be replaced by other components performing different functions.

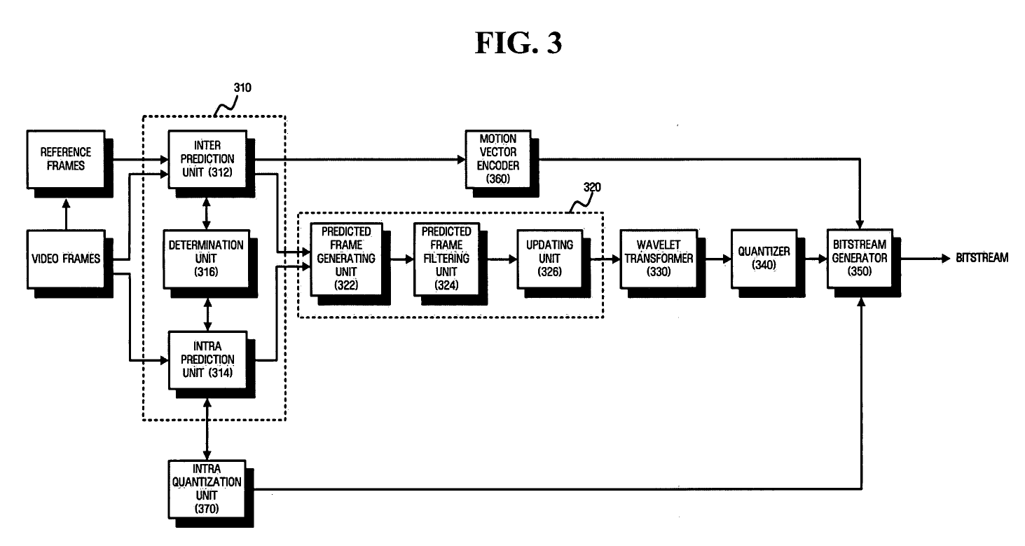

FIG. 3 is a block diagram of a video encoder supporting an intra predictive coding mode according to an exemplary embodiment of the present invention.

Referring to FIG. 3, the video encoder includes a mode determiner 310, a temporal filter 320, a wavelet transformer 330, a quantizer 340, and a bitstream generator 350.

The mode determiner 310 determines a mode in which each block in a frame currently being encoded (“current frame”) will be encoded. To accomplish this function, the mode determiner 310 includes an inter prediction unit 312, an intra prediction unit 314, and a determination unit 316. The inter prediction unit 312 estimates motion between each block in the current frame and a corresponding reference block using one or more reference frames and obtains a motion vector. Following the motion estimation, the inter prediction unit 312 calculates a difference metric between the block and the corresponding reference block. While a mean of absolute difference (MAD) is used as the difference metric in the present invention, sum of absolute difference (SAD) or other metrics may be used. The difference metric is used to calculate a cost for a coding scheme.

The intra prediction unit 314 encodes each block in the current frame using information within the current frame. An intra predictive coding mode is used in the present exemplary embodiment to generate an intra predicted block for each block in the current frame with reference to an intra basis block for the block and calculate a difference metric between the block and the corresponding intra predicted block. A process of generating an intra basis block and an intra predicted block will be described in more detail later.

The determination unit 316 receives difference metrics for each block in the current frame from the inter prediction unit 312 and the intra prediction unit 314 and determines a coding mode for the block. For example, to determine the coding mode for each block, the determination unit 316 may compare costs for an intra predictive coding mode and an inter predictive mode. Costs Cᵢₙₜₑᵣ and Cᵢₙₜᵣₐ for inter predictive coding and intra predictive coding a block are defined by Equation (1) as follows:
Cᵢₙₜₑᵣ=Dᵢₙₜₑᵣ+λ(MV_bits+Mode_bitsᵢₙₜₑᵣ)
Cᵢₙₜᵣₐ=Dᵢₙₜᵣₐ+λ(INTRA_bits+Mode_bitsᵢₙₜᵣₐ) (1)

Dᵢₙₜₑᵣ is a difference metric between the block and a corresponding reference block for inter predictive coding and Dᵢₙₜᵣₐ is a difference metric between the block and a corresponding intra predicted block for intra-coding. MV_bits and INTRA_bits respectively denote the number of bits allocated to a motion vector associated with the block and the intra basis block. Mode_bitsᵢₙₜₑᵣ and Mode_bitsᵢₙₜᵣₐ denote the number of bits required to indicate that the block is encoded as an inter-block and intra-block, respectively. λ is a Lagrangian coefficient used to control the balance among the bits allocated to a motion vector and a texture (image).

Using the Equation (1), the determination unit 316 can determine the mode in which each block in the current frame will be encoded. For example, when a cost for inter predictive coding is less than a cost for intra predictive coding, the determination unit 316 determines that the block will be inter-coded. Conversely, when the cost for intra predictive coding is less than the cost for inter predictive coding, the determination unit 316 determines that the block will be intra-coded.

Once a mode for each block in the current frame is determined, the temporal filter 320 generates a predicted frame for the current frame, compares the current frame with the predicted frame, and removes temporal redundancies within the current frame. The temporal filter 320 may also remove block artifacts that can be generated during prediction (inter prediction or intra prediction). The block artifacts that appear along block boundaries in the predicted frame generated on a block-by-block basis significantly degrade the visual quality of image. Thus, in addition to a predicted frame generating unit 322 generating the predicted frame for the current frame, the temporal filter 320 includes a predicted frame filtering unit 324 removing block artifacts in the predicted frame. The predicted frame filtering unit 324 may perform filtering on the predicted frame to remove a block artifact introduced at a boundary between an intra predicted block and an inter predicted block as well as a block artifact at a boundary between inter predicted blocks. Thus, the predicted frame filtering unit 324 can be used for a video coding algorithm not supporting an intra predictive coding mode. Furthermore, the temporal filter 320 may further include an updating unit 326 when scalable video coding includes the operation of updating frames. Thus, the updating unit 326 is not required for scalable video coding which does not include the updating operation or DCT-based video coding.

More specifically, the predicted frame generating unit 322 generates a predicted frame using a reference block or an intra-predicted block corresponding to each block in a current frame.

A comparator (not shown) compares the current frame with the predicted frame to thereby generate a residual frame. Before generating the residual frame, the predicted frame filtering unit 324 performs filtering on the predicted frame to reduce block artifacts that can occur in the residual frame. That is, the comparator compares the current frame with the predicted frame subjected to filtering, thereby generating the residual frame. A process of filtering the predicted frame will be described in more detail later. Conventionally, a filtering process for the predicted frame was mostly used for closed-loop video coding such as H.264 video coding schemes. The filtering process was not used for open-loop scalable video coding that allows an encoded bitstream to be truncated by a predecoder for decoding. That is, since encoding conditions are different from decoding conditions, the open-loop scalable video coding did not employ filtering of a predicted frame. However, scalable video coding including filtering of a predicted frame provides improved video quality. Therefore, the present invention includes the operation of filtering a predicted frame.

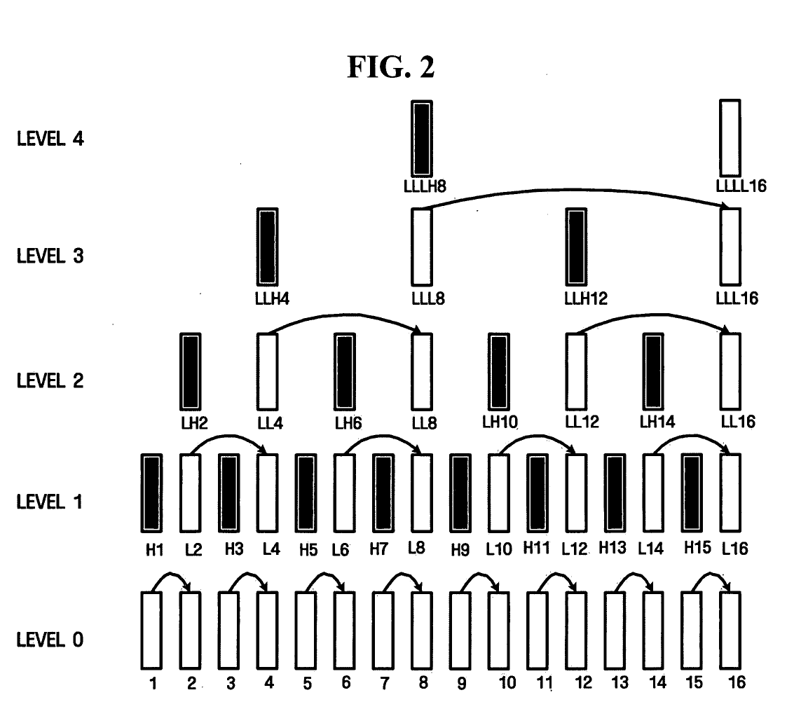

The updating unit 326 updates the residual frames (H frames) and original video frames in an MCTF-based scalable video coding algorithm and generates a single low-pass subband (L frame) and a plurality of high-pass subbands (H frames). Referring to FIG. 2, residual frames obtained from frames 1, 3, 5, 7, 9, 11, 13, and 15, and frames 2, 4, 6, 8, 10, 12, 14, and 16 are updated to generate subbands in temporal level 1. L frames in temporal level 1 are subjected to motion estimation or intra prediction by the mode determiner 310, pass through the predicted frame generating unit 322 and the predicted frame filtering unit 324, and are input into the updating unit 326. The updating unit 326 generates subbands (L frames and H frames) in temporal level 2 using residual frames from the L frames in temporal level 1 and the L frames in temporal level 1. In a similar fashion, the L frames in temporal level 2 is used to generate subbands in temporal level 3. L frames in temporal level 3 is used to a single H frame and a single L frame in temporal level 4. While the updating operation is performed by a 5/3 filter, a Haar filter or a 7/5 filter may be used as is conventionally done.

The wavelet transformer 330 performs wavelet transform on the frames subjected to temporal filtering by the temporal filter 320. In a currently known wavelet transform, a frame is decomposed into four sections (quadrants). A quarter-sized image (L image), which is substantially the same as the entire image, appears in a quadrant of the frame, and information (H image), which is needed to reconstruct the entire image from the L image, appears in the other three quadrants. In the same way, the L image may be decomposed into a quarter-sized LL image and information needed to reconstruct the L image. Image compression based on the wavelet transform is applied to JPEG 2000 compression technique. Spatial redundancy of a frame can be removed by wavelet transform. In addition, in the wavelet transform, unlike in the DCT transform, original image data is stored in a size-reduced form. Thus, the sized-reduced image enables spatially scalable video coding. While it is described above in the exemplary embodiment illustrated in FIG. 3 that wavelet transform is used as a spatial transformation technique in scalable video coding supporting an intra predictive coding mode, DCT may also be used when the intra predictive coding mode is applied to the existing video coding standards such as MPEG-2, MPEG-4, and H.264.

The quantizer 340 uses an embedded quantization algorithm to quantize the wavelet transformed frames. The embedded quantization involves quantization, scanning, and entropy coding. Texture information that will be contained in a bitstream is generated by the embedded quantization.

A motion vector that should be also contained in the bitstream in order to decode a block encoded in an inter predictive mode may be encoded using lossless compression. A motion vector encoder 360 encodes a motion vector obtained from the inter prediction unit 314 using variable length coding or arithmetic coding and transmits the encoded motion vector to the bitstream generator 350.

The bitstream also contains an intra basis block in order to decode a block encoded in an intra predictive coding mode. Before being transmitted to the bitstream generator 350, the intra basis block is not compressed or encoded. Alternatively, the intra basis block may be quantized or be encoded using variable length coding or arithmetic coding.

The video encoder of FIG. 3 uses a quantized intra basis block. More specifically, when a block is encoded in an intra predictive coding mode, the intra prediction unit 314 generates an intra basis block for the block and an intra predicted block using the intra basis block.

The intra prediction unit 314 obtains a difference metric by comparing the block with the intra predicted block and transmits the difference metric to the determination unit 316. When the determination unit 316 determines that the block is encoded in an intra predictive coding mode, the intra predicted block is provided to the temporal filter 420.

In another exemplary embodiment, the intra prediction unit 314 predicts an intra basis block from neighboring subblocks surrounding the block and generates a residual intra basis block by comparing the predicted intra basis block with the original intra basis block. The intra quantization unit 370 quantizes the residual intra basis block in order to reduce the amount of information and sends the quantized residual intra basis block back to the intra prediction unit 314. The quantization may include a transformation operation to reduce the amount of information in the residual intra basis block. The intra prediction unit 314 adds the quantized residual intra basis block to the intra basis block predicted from the neighboring subblocks and generates a new intra basis block. The intra prediction unit 314 then generates an intra predicted block by interpolating the new intra basis block and transmits the intra predicted block to the temporal filter 320 in order to be used in generating residual blocks.

After generating a predicted frame using intra predicted blocks and inter predicted blocks, the temporal filter 320 compares the predicted frame with an original video frame to thereby generate a residual frame. The residual frame passes through the wavelet transformer 330 and the quantizer 340 and is combined into a bitstream. The bitstream generator 350 generates a bitstream using texture information received from the quantizer 340, motion vectors received from the motion vector encoder 360, and quantized intra basis blocks received from the intra quantization unit 370.

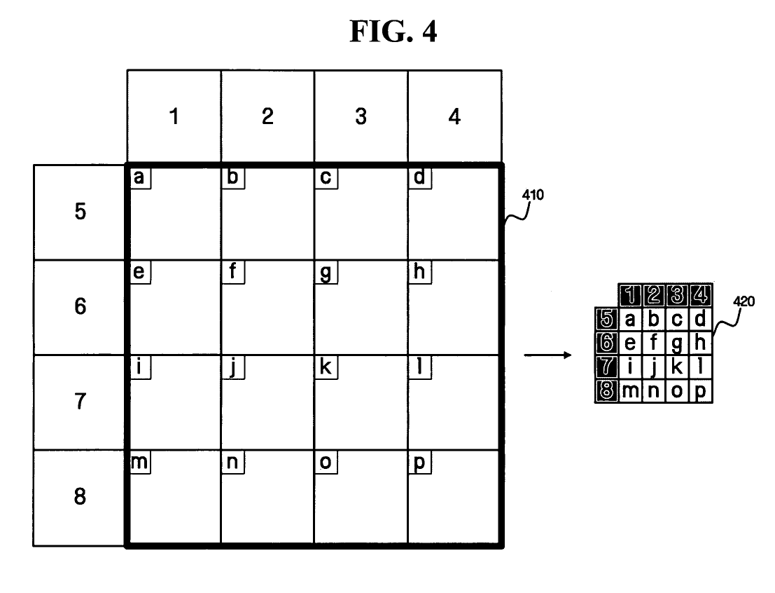

FIG. 4 is a diagram for explaining a process of generating an intra basis block according to an exemplary embodiment of the present invention.

Referring to FIG. 4, to encode a block 410 in an intra predictive coding mode, the block 410 is divided into a plurality of subblocks. In the present exemplary embodiment, since the block is divided into 16 subblocks for intra prediction, an intra basis block has a size of 4*4 pixels. A block size may be determined depending on combinations of temporal and spatial scalabilities. The block size may be determined using a scaling factor defined as the ratio of view layer to encoded layer. For example, when the scaling factor is 1, a block size is 16*16 pixels. When the scaling factor is 2, the block size is 32*32 pixels.

After the block 410 is divided into 16 subblocks, a representative value is determined for each subblock. The value of one pixel in each subblock is determined as the representative value of the subblock. For example, the representative value of a subblock may be a value of an upper-left pixel in the subblock. Alternatively, the representative value may be the average or median of pixels in the subblock. The representative values of the subblocks in the block 410 are gathered to generate an intra basis block 420 with a size of 4*4 pixels.

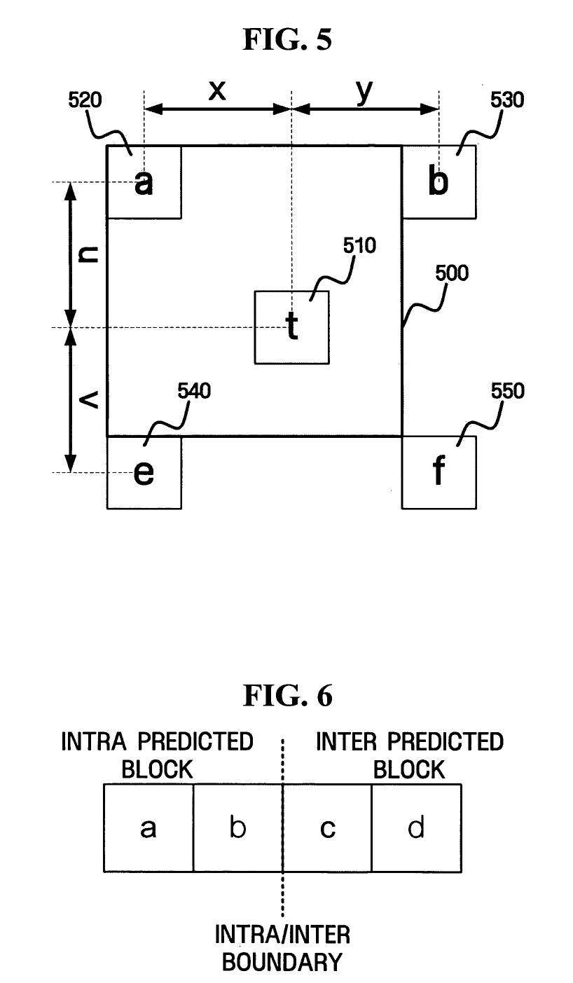

FIG. 5 is a diagram for explaining a process of generating an intra predicted block using the intra basis block 420 according to an exemplary embodiment of the present invention. Referring to FIG. 5, each pixel in the intra predicted block is generated using the values of pixels in the intra basis block. For example, the value of a pixel t 510 may be calculated using the values of pixel a 520, pixel b 530, pixel e 540, and pixel f 550 in the intra basis block 420. In this case, the value of pixel t 510 can be obtained by interpolating the values of neighboring pixels in an intra basis block. The value of pixel t 510 is defined by Equation (2) as follows:

$$t = \frac{\frac{ay + bx}{x + y} v + \frac{ey + fx}{x + y} u}{u + v} \qquad ( 2 )$$

where t is the value of pixel t 510, a, b, e, and f are the values of pixel a 520, pixel b 530, pixel e 540, and pixel f 550, respectively, x and y are horizontal distances between the pixel t 510 and the pixel a 520 and between the pixel t 510 and the pixel b 530, respectively, and u and v are vertical distances between the pixel t 510 and the pixel e 540 and between the pixel t and the pixel f 550, respectively.

Once the intra predicted block is generated using pixels in the intra basis block (420 of FIG. 4), a difference metric between the block (410 of FIG. 4) and the intra predicted block is provided to the determination unit (316 of FIG. 3). The determination unit 316 uses the difference metric to determine whether to encode the block 410 in an intra predictive coding mode.

In a first exemplary embodiment, when the determination unit determines that the block 410 is encoded in an intra predictive coding mode, the intra prediction unit 314 transmits the intra predicted block to the temporal filter 320.

In a second exemplary embodiment, to reduce the amount of information in an intra basis block, the intra prediction unit 314 predicts an intra basis block using information from neighboring subblock blocks surrounding the block 410 and generate a residual intra basis block by comparing the predicted intra basis block with the previous intra basis block. The intra quantization unit 370 quantizes the residual intra basis block in order to reduce the amount of information and sends the quantized residual intra basis block back to the intra prediction unit 314. The intra prediction unit 314 adds the quantized residual intra basis block to the predicted intra basis block to thereby generate a new intra basis block. Then, the intra prediction unit 314 generates an intra predicted block using the new intra basis block and transmits the intra predicted block to the temporal filter 320. The second exemplary embodiment offers similar performance to the first exemplary embodiment but is advantageous over the first exemplary embodiment for filtering a predicted frame in the predicted frame filtering unit 324. The second exemplary embodiment also suffers less artifacts at a boundary between an inter-coded block and an intra-coded block at a low bit-rate than the first exemplary embodiment.

A process of predicting an intra basis block and quantizing a residual intra basis block generated with the predicted intra basis block according to the second exemplary embodiment will now be described in more detail with reference to FIG. 4. As described earlier, the intra basis block 420 generated using representative values for subblocks in the block 410 is used to determine a mode in which the block 410 will be encoded. However, in the present exemplary embodiment, an intra basis block is generated using information from neighboring subblocks. When upper-left pixels of the subblocks in the block 410 are determined as pixels in the previous intra basis block 420, an intra basis block for the block 410 is predicted using information from a block (subblocks) located above the block 410 (“upside block”) and from a block (or subblocks) located to the left of the block 410 (“left-side block”). The intra basis block may be predicted according to the following rules:

1. When the upside block and the left-side block are encoded in an inter predictive mode, information from the blocks has the median value of all possible pixel values. For example, when pixel values ranges from 0 to 255, the median value is 128.

2. When the upside block and the left-side block are respectively encoded in an intra predictive coding mode and an inter predictive mode, information from the upside block is representative values of subblocks 1, 2, 3, and 4 adjacent to the block 410 while information from the left-side block is the median value of all pixel values.

3. When the left-side block and the upside block are respectively encoded in an intra predictive coding mode and an inter predictive mode, information from the left-side block is representative values of subblocks 5, 6, 7, and 8 adjacent to the block 410 while information from the upside block is the median value of all pixel values.

4. When the upside block and the left-side block are encoded in an intra predictive coding mode, information from the upside block is representative values of subblocks 1, 2, 3, and 4 adjacent to the block 410 while information from the left-side block is representative values of subblocks 5, 6, 7, and 8 adjacent to the block 410.

Using the above criteria, values of pixels in the intra basis block 420 are determined from Equation (3) as follows:

$$PredictedPixel = \frac{UpSidePixel * Dis\_X + LeftSidePixel * Dis\_Y}{Dis\_X + Dis\_Y} \qquad ( 3 )$$

Here, PredictedPixel is a predicted pixel value in the intra basis block 420, UpSidePixel and LeftSidePixel are respectively information from upside block and left-side block, and DisX and DisY are respectively a distance from a pixel having a pixel value LeftSidePixel of the left-side block and a distance from a pixel having a pixel value UpSidePixel of the upside block.

For example, when the upside block and the left-side block in FIG. 4 are encoded in an inter predictive mode and an intra predictive coding mode, respectively, UpSidePixel is 128 and LeftSidePixel is representative values of subblocks 5, 6, 7, and 8. If the representative values of subblocks 5, 6, 7, and 8 are 50, 60, 70, and 80, respectively, the values of pixels a, b, c, and d in the intra basis block 420 are (128*1+50*1)/(1+1), (128*2+50*1)/(2+1), (128*3+50*1)/(3+1), and (128*4+50*1)/(4+1), respectively. Similarly, the values of pixels e, f, g, and h are (128*1+60*2)/(1+2), (128*2+60*2)/(2+2), (128*3+60*2)/(3+2), and (128*4+60*2)/(4+1), respectively. The values of pixels i, j, k, and l are (128*1+70*3)/(1+3), (128*2+70*3)/(2+3), (128*3+70*3)/(3+3), and (128*4+70*3)/(4+3), respectively. The values of the last four pixels m, n, o, and p are (128*1+80*4)/(1+4), (128*2+80*4)/(2+4), (128*3+80*4)/(3+4), and (128*4+80*4)/(4+4), respectively.

On the other hand, when the upside block and the left-side block are encoded in an intra predictive coding mode, UpSidePixel is representative values of subblocks 1, 2, 3, and 4 and LeftSidePixel is representative values of subblocks 5, 6, 7, and 8. If the representative values of subblocks 1, 2, 3, and 4 are 10, 20, 30, and 40 and the representative values of subblocks 5, 6, 7, and 8 are 50, 60, 70, and 80, the values of pixels a, b, c, and d in the intra basis block 420 are (10*1+50*1)/(1+1), (20*2+50*1)/(2+1), (30*3+50*1)/(3+1), and (40*4+50*1)/(4+1), respectively. Similarly, the values of pixels e, f, g, and h are (10*1+60*2)/(1+2), (20*2+60*2)/(2+2), (30*3+60*2)/(3+2), and (40*4+60*2)/(4+1), respectively. The values of pixels i, j, k, and 1 are (10*1+70*3)/(1+3), (20*2+70*3)/(2+3), (30*3+70*3)/(3+3), and (40*4+70*3)/(4+3), respectively. The values of the last four pixels m, n, o, and p are (10*1+80*4)/(1+4), (20*2+80*4)/(2+4), (30*3+80*4)/(3+4), and (40*4+80*4)/(4+4), respectively.

In a similar fashion, pixel values in the intra basis block 420 can be predicted when the upside block and the left-side block are encoded in an intra predictive coding mode and in an inter predictive mode, respectively, or when the upside block and the left-side block are encoded in an inter predictive mode.

After pixel values in the intra basis block 420 are predicted, the pixel values in the predicted intra basis block 420 are subtracted from the pixel values in the original intra basis block to determine pixel values in a residual intra basis block. The determined pixel values in the residual intra basis block may be directly subjected to quantization. However, to reduce spatial correlation, the pixel values are subjected to Hadamard transform before quantization. Quantization may be performed by a suitable quantization parameter Qp in a similar to 16*16 quantization in H.264. The intra prediction unit 314 adds the quantized residual intra basis block to the intra basis block predicted using information from the neighboring subblocks and generates a new intra basis block. The intra prediction unit 314 then generates an intra predicted block by interpolating the new intra basis block and transmits the intra predicted block to the temporal filter 320.

While it has been described above that a block is divided into 16 subblocks to generate an intra basis block, the block can be divided into a number of subblocks less than or greater than 16. A luminance (luma) block and a chrominance (chroma) block can be divided into a different number of subblocks, respectively. For example, the luma and chroma blocks may be divided into 16 and 8 subblocks, respectively.

As described above, when an intra predicted block is generated by interpolation, few block artifacts occur at a boundary between intra predicted blocks. However, block artifacts may occur between an intra predicted block and an inter predicted block since both blocks have different characteristics.

FIG. 6 is a diagram for explaining a process of filtering a predicted frame according to an exemplary embodiment of the present invention.

Various filtering techniques may be used to filter the values of pixels between an intra predicted block and inter predicted block. For example, when a very simple {1, 2, 1} filter is used, the values of pixels between the intra predicted block and the inter predicted block are determined using Equation (4):
b′=(a+b*2+c)/4
c′=(b+c*2+d)/4 (4)
where b′ and c′ are filtered pixel values and a, b, c, and d are pixel values before being filtered. It is demonstrated experimentally that use of a simple filter can significantly reduce block artifacts.

Filtering can also be performed between inter predicted blocks or between intra predicted blocks.

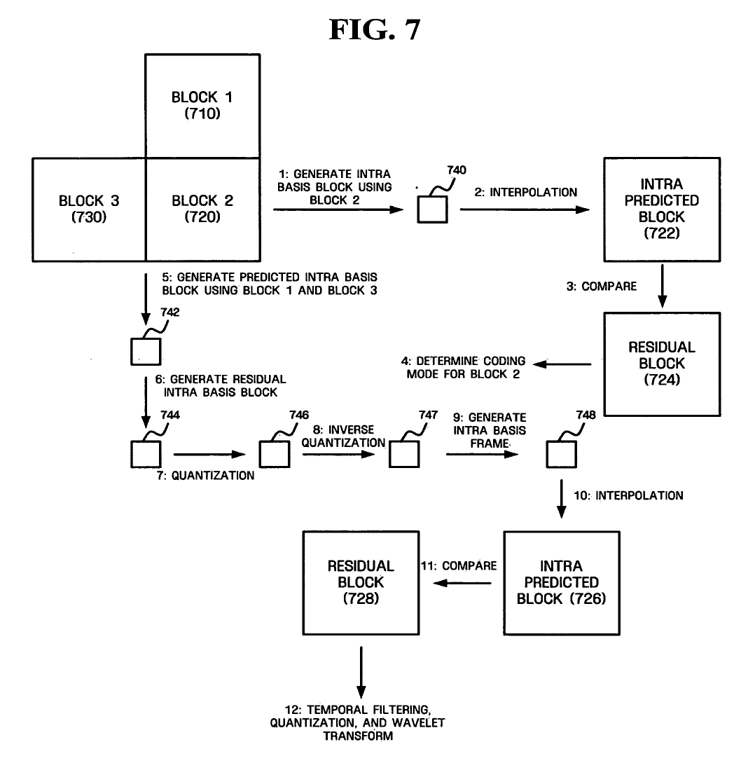

FIG. 7 illustrates the process of an intra predictive coding mode according to an exemplary embodiment of the present invention.

For convenience of explanation, it is assumed that coding modes for block 1 710 and block 3 730 have been already determined. A coding mode is first determined for encoding block 2 720. The block 2 720 is encoded according to the following process:

1. Generate an intra basis block 740 using the block 2 720.

2. Generate an intra predicted block 722 by interpolating the intra basis block 740.
3. Generate a residual block 724 by comparing the intra predicted block 722 with the block 2 720

4. Determine a coding mode for the block 2 720 by comparing a cost for encoding the residual block 724 with a cost for encoding a residual block (not shown) generated by inter predictive coding.

5. When an intra predictive coding mode is determined as a coding mode for the block 2 720, generate a predicted intra basis block 742 obtained by predicting pixel values in the intra basis block 740 using the neighboring blocks 710 and 730.

6. Generate a residual intra basis block 744 by comparing the predicted intra basis block 742 and the intra basis block 740.

7. Quantize the residual intra basis block 744. Before quantization, the residual intra basis block 744 may be subjected to Hadamard transform to reduce spatial correlation.

8. Apply inverse quantization to the quantized residual intra basis block 746 for transmission to a decoder. The inversely quantized residual intra basis block 747 is almost similar to the residual intra basis block 744 before being quantized. When the Hadamard transform is performed before quantization, perform inverse Hadamard transform.

9. Generate a new intra basis block 748 by adding the inversely quantized residual intra basis block 747 to the predicted intra basis block 742 created using the neighboring blocks 710 and 730. The new intra basis block 748 is similar but is not identical to the original intra basis block 740.
10. Generate an intra predicted block 726 by interpolating the intra basis block 748. The intra predicted block 726 is also similar to the intra predicted block 722.

11. Generate a residual block 728 by comparing the intra predicted block 726 with the block 2 720. The residual block 728 is similar to the residual block 724.

12. Perform temporal filtering, wavelet transform, and quantization on the residual block 724 to generate texture information that will be contained in a bitstream.

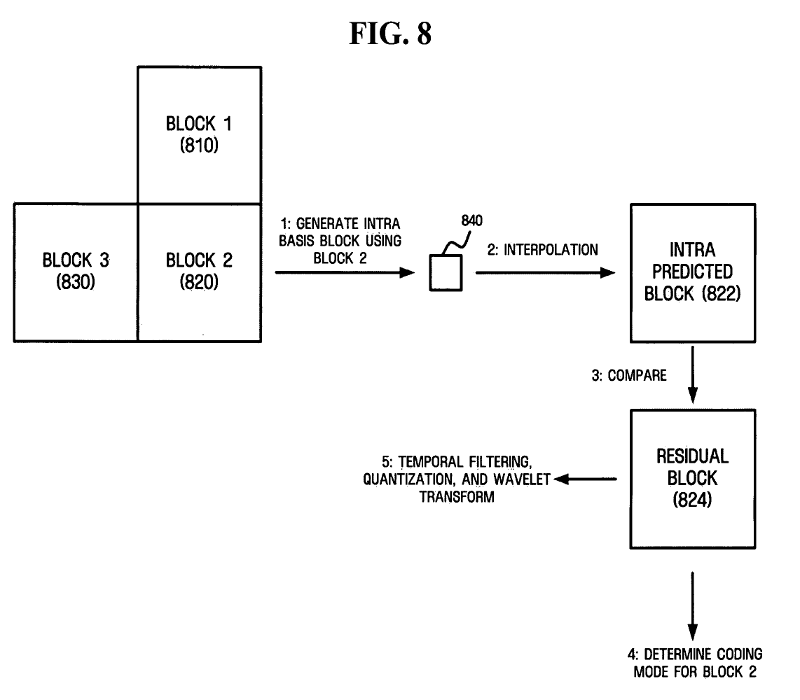

FIG. 8 illustrates the process of an intra predictive coding mode according to another exemplary embodiment of the present invention.

For convenience of explanation, it is assumed that coding modes for block 1 810 and block 3 830 have been already determined. A coding mode is first determined for encoding block 2 820. The block 2 820 is encoded according to the following process:

1. Generate an intra basis block 840 using block 2 820.

2. Generate an intra predicted block 822 by interpolating the intra basis block 840.

3. Generate a residual block 824 by comparing the intra predicted block 822 with the block 2 820.

4. Determine a coding mode for the block 2 820 by comparing a cost for encoding the residual block 824 with a cost for encoding a residual block (not shown) created by inter predictive coding.

5. When an intra predictive coding mode is determined as the coding mode for the block 2 820, perform temporal filtering, wavelet transform, and quantization on the residual block 824 to generate texture information that will be contained in a bitstream.

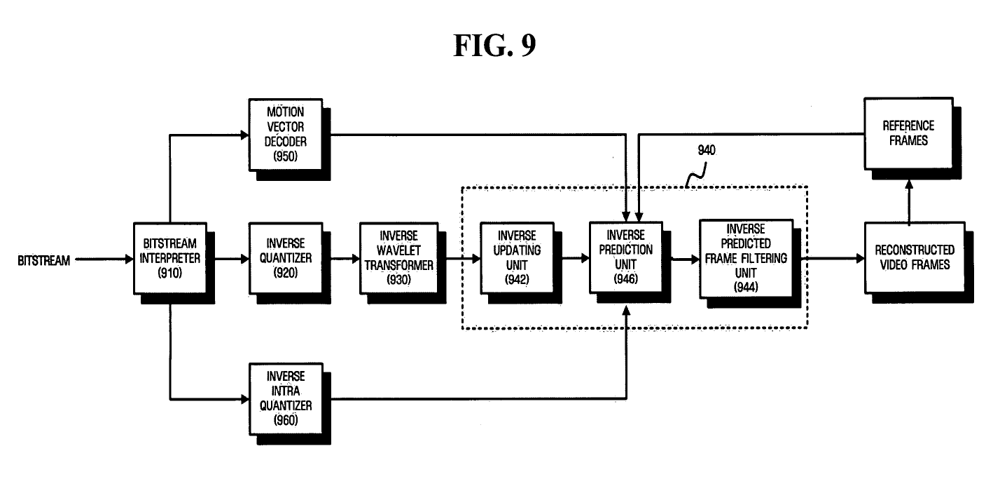

FIG. 9 is a block diagram of a video decoder according to an exemplary embodiment of the present invention.

For convenience of explanation, the video decoder is assumed to decode a bitstream created by the encoding process illustrated in FIG. 7. Basically, the video decoder performs the inverse operation of an encoder on received bitstream in order to reconstruct video frames. To accomplish this, the video decoder includes a bitstream interpreter 910, an inverse quantizer 920, an inverse wavelet transformer 930, and an inverse temporal filter 940.

The bitstream interpreter 910 interprets a bitstream to obtain texture information, an encoded motion vector, and a quantized residual intra basis block that are then provided to the inverse quantizer 920, a motion vector decoder 950, and an inverse intra quantizer 960, respectively. The quantized residual intra basis block is subjected to inverse quantization and then is added to a predicted intra basis block obtained using information from neighboring blocks, thereby generating a new intra basis block.

The inverse quantizer 920 inversely quantizes texture information and creates transform coefficients in the wavelet domain. The inverse wavelet transformer 930 performs inverse wavelet transform on the transform coefficients to obtain a single low-pass subband and a plurality of high-pass subbands on a GOP-by-GOP basis.

The inverse temporal filter 940 uses the high-pass and low-pass subbands to reconstruct video frames. To this end, the inverse temporal filter 940 includes an inverse prediction unit 946, which receives motion vectors and residual intra basis blocks from the motion vector decoder 950 and the inverse intra quantizer 960, respectively, and reconstructs a predicted frame.

Meanwhile, when the encoding process does not include an updating operation, the previously reconstructed frames can be used as a reference to reconstruct a predicted frame. On other hand, when the encoding process includes an updating operation, the inverse temporal filter 940 further includes an inverse updating unit 942. Similarly, when the encoding process includes filtering of a predicted frame, the inverse temporal filter 940 further includes an inverse predicted frame filtering unit 944 filtering predicted frames obtained by an inverse prediction unit 946.

When the decoder is designed to decode a bitstream created by the encoding process illustrated in FIG. 8, an intra basis block is obtained from the bitstream instead of the quantized residual intra basis block. Thus, it is not necessary to generate a predicted intra basis block using neighboring blocks.

While FIG. 9 shows a scalable video decoder, it will be understood by those of ordinary skill in the art that some of the components shown in FIG. 9 may be modified or replaced to reconstruct video frames from a bitstream produced by DCT-based encoding. Therefore, it is to be understood that the above-described exemplary embodiments have been provided only in a descriptive sense and will not be construed as placing any limitation on the scope of the invention.

According to the present invention, a novel intra predictive coding mode is provided. The intra predictive coding mode reduces block artifacts introduced by video coding and improves video coding efficiency. A method of filtering a predicted frame that can also be effectively used in scalable video coding to reduce the effect of block artifacts is also provided.

What is claimed is:

1. A video encoding method comprising:
determining a coding mode for each block in an input video frame as one of an inter predictive coding mode and an intra predictive coding mode;
generating a predicted frame for the input video frame based on predicted blocks obtained according to the coding mode which is determined; and
encoding the input video frame based on the predicted frame;
wherein if the intra predictive coding mode is determined as the coding mode, an intra basis block composed of representative values of a block is generated for the block and the intra basis block is interpolated to generate an intra predicted block for the block.

2. The method of claim 1, wherein in the determining of the coding mode, the coding mode is determined by comparing a cost for encoding the block in the inter predictive coding mode with a cost for encoding the block in the intra predictive coding mode.

3. The method of claim 2, wherein the cost for encoding the block in the inter predictive coding mode is calculated based on a difference metric between the block and a reference block in a reference frame corresponding to the block, a number of bits allocated to encode a motion vector between the block and the reference block, and a number of bits required to indicate that the block is inter-coded, and the cost for encoding the block in the intra predictive coding mode is calculated based on a difference metric between the block and an intra predicted block corresponding to the block, a number of bits allocated to an intra basis block corresponding to the block, and a number of bits required to indicate that the block is intra-coded.

4. The method of claim 3, wherein if the block is encoded in the intra predictive coding mode, the intra predicted block used to calculate the cost is contained in the predicted frame.

5. The method of claim 1, wherein values of pixels in the intra basis block are representative values of subblocks in the block.

6. The method of claim 5, wherein a representative value of each subblock is a value of one pixel in the subblock.

7. The method of claim 5, wherein a number of subblocks is 16.

8. The method of claim 1, wherein if the intra predictive coding mode is determined as the coding mode for the block, the intra basis block used in generating an intra predicted block corresponding to the block is produced based on information from neighboring blocks surrounding the block.

9. The method of claim 8, wherein the intra basis block is generated by creating a residual intra basis block by comparing a first intra basis block generated based on information from the block with a second intra basis block generated based on the information from the neighboring blocks, quantizing the residual intra basis block, inversely quantizing the quantized residual intra basis block, and adding the inversely quantized residual intra basis block to the second intra basis block.

10. The method of claim 9, wherein the information of the neighboring blocks is representative values of subblocks contained in an upside block located above the block and a left-side block located to the left of the block.

11. The method of claim 10, wherein the information of a block for which an inter predictive coding mode is determined is 128.

12. The method of claim 10, wherein if PredictedPixel is the value of each pixel in the second intra basis block, UpSidePixel and LeftSidePixel are representative values for the upside block and the left-side block, respectively, and DisX and DisY are a distance from a pixel having a pixel value LeftSidePixel of the left-side block and a distance from a pixel having a pixel value UpSidePixel of the upside block, respectively, the values of pixels in the second intra basis block are calculated by:
$$PredictedPixel = \frac{UpSidePixel * Dis\_X + LeftSidePixel * Dis\_Y}{Dis\_X + Dis\_Y} .$$

13. The method of claim 1, wherein the input video frame is encoded based on scalable video coding.

14. A video encoder comprising:
a mode determiner which determines a coding mode for each block in an input video frame as one of an inter predictive coding mode and an intra predictive coding mode and generates predicted blocks according to the coding mode which is determined;
a temporal filter which generates a predicted frame for the input video frame based on the predicted blocks and removes temporal redundancies within the input video frame based on the predicted frame;
a spatial transformer which removes spatial redundancies within the input video frame in which the temporal redundancies have been removed;
a quantizer which quantizes the input video frame in which the spatial redundancies have been removed; and
a bitstream generator generating a bitstream containing the video frame which has been quantized,
wherein the mode determiner generates an intra basis block composed of representative values for a block for which an intra predictive coding mode is determined and then generates an intra predicted block for the block by interpolating the intra basis block.

15. The encoder of claim 14, wherein the mode determiner determines the coding mode for the block by comparing a cost for encoding the block in the inter predictive coding mode with a cost for encoding the block in the intra predictive coding mode.

16. The encoder of claim 15, wherein the mode determiner calculates the cost for encoding the block in the inter predictive coding mode based on a difference metric between the block and a reference block in a reference frame corresponding to the block, a number of bits allocated to encode a motion vector between the block and the reference block, and a number of bits required to indicate that the block is inter-coded, and the cost for encoding the block in the intra predictive coding mode is calculated based on a difference metric between the block and an intra predicted block corresponding to the block, a number of bits allocated to an intra basis block corresponding to the block, and a number of bits required to indicate that the block is intra-coded.

17. The encoder of claim 15, wherein if the intra predictive coding mode is determined as the coding mode for the block, the mode determiner provides the intra predicted block used to calculate the cost to the temporal filter.

18. The encoder of claim 14, wherein the mode determiner determines a representative value of each subblock in the block as a value of each pixel in the intra basis block.

19. The encoder of claim 18, wherein a representative value of each subblock is a value of one pixel in the subblock.

20. The encoder of claim 14, wherein a size of the intra basis block generated by the mode determiner is 4*4 pixels.

21. The encoder of claim 14, wherein the mode determiner determines values of pixels in the intra basis block based on information from neighboring blocks surrounding the block.

22. The encoder of claim 21, wherein the mode determiner determines a value obtained by creating a residual intra basis block by comparing a first intra basis block generated based on information from the block with a second intra basis block generated based on the information from the neighboring blocks, quantizing the residual intra basis block, inversely quantizing the quantized residual intra basis block, and adding the inversely quantized residual intra basis block to the second intra basis block as a value of each pixel in the intra basis block.

23. The encoder of claim 22, wherein the information from the neighboring blocks used by the mode determiner is representative values of the subblocks contained in an upside block located above the block and a left-side block located to the left of the block.

24. The encoder of claim 23, wherein the information of a block for which an inter predictive coding mode is determined is 128.

25. The encoder of claim 23, wherein if PredictedPixel is the value of each pixel in the second intra basis block, UpSidePixel and LeftSidePixel are representative values for the upside block and the left-side block, respectively, and DisX and DisY are a distance from a pixel having a pixel value LeftSidePixel of the left-side block and a distance from a pixel having a pixel value UpSidePixel of the upside block, respectively, the mode determiner calculates the values of pixels in the second intra basis block by:
$$PredictedPixel = \frac{UpSidePixel * Dis\_X + LeftSidePixel * Dis\_Y}{Dis\_X + Dis\_Y} .$$

26. The encoder of claim 14, wherein the temporal filter and the spatial transformer remove redundancies within the video frame based on scalable video coding.

27. A video decoding method comprising:
interpreting an input bitstream and obtaining texture information, motion vector information, and intra basis block information;
generating a predicted frame based on the texture information, the motion vector information, and the intra basis block information; and
reconstructing a video frame based on the predicted frame,
wherein an intra predicted block in the predicted frame is obtained by adding residual block information contained in the texture information to intra predicted block information obtained by interpolating the intra basis block information.

28. The method of claim 27, wherein the intra basis block information has a size of 4*4 pixels.

29. The method of claim 27, wherein the intra basis block information is a quantized residual intra basis block that is subjected to inverse quantization, a predicted intra basis block is obtained based on information from a block previously reconstructed among blocks adjacent to the intra predicted block, an intra basis block is obtained by adding the inversely quantized residual intra basis block to the predicted intra basis block, and the intra predicted block is obtained by interpolating the intra basis block.

30. The method of claim 29, wherein the information from the adjacent blocks is representative values of subblocks contained in blocks located above and to the left of the intra predicted block.

31. The method of claim 30, wherein the information of one of the blocks located above and to the left of the intra predicted block, for which an inter predictive coding mode is determined, is 128.

32. The method of claim 30, wherein the input bitstream is encoded based on scalable video coding.

33. A video decoder comprising:
a bitstream interpreter which interprets a bitstream and obtains texture information, motion vector information, and intra basis block information;
an inverse quantizer which inversely quantizes the texture information;
an inverse spatial transformer which performs inverse spatial transform on the inversely quantized texture information and generates a residual frame; and
an inverse temporal filter which generates a predicted frame based on the residual frame, the motion vector information, and the intra basis block information and reconstructs a video frame based on the predicted frame,
wherein the inverse temporal filter generates an intra predicted block in the predicted frame by adding residual block information contained in the residual frame to intra predicted block information obtained by interpolating the intra basis block information.

34. The video decoder of claim 33, wherein the intra basis block information has a size of 4*4 pixels.

35. The video decoder of claim 33, wherein the intra basis block information is a quantized residual intra basis block that is then subjected to inverse quantization, a predicted intra basis block is obtained based on information from a block previously reconstructed among blocks adjacent to the intra predicted block, an intra basis block is obtained by adding the inversely quantized residual intra basis block to the predicted intra basis block, and the intra predicted block is obtained by interpolating the intra basis block.

36. The video decoder of claim 35, wherein the information from the adjacent blocks is representative values of subblocks contained in blocks located above and to the left of the intra predicted block.

37. The video decoder of claim 36, wherein the information of one of the blocks located above and to the left of the intra predicted block, for which an inter predictive coding mode is determined, is 128.

38. The video decoder of claim 36, wherein the input bitstream is encoded based on scalable video coding.

39. A recording medium having a computer readable program recorded therein, the program executing a video encoding method comprising:
determining a coding mode for each block in an input video frame as one of an inter predictive coding mode and an intra predictive coding mode;
generating a predicted frame for the input video frame based on predicted blocks obtained according to the coding mode which is determined; and
encoding the input video frame based on the predicted frame;
wherein if the intra predictive coding mode is determined as the coding mode, an intra basis block composed of representative values of a block is generated for the block and the intra basis block is interpolated to generate an intra predicted block for the block.

40. A recording medium having a computer readable program recorded therein, the program executing a video decoding method comprising:
interpreting an input bitstream and obtaining texture information, motion vector information, and intra basis block information;
generating a predicted frame based on the texture information, the motion vector information, and the intra basis block information; and
reconstructing a video frame based on the predicted frame,
wherein an intra predicted block in the predicted frame is obtained by adding residual block information contained in the texture information to intra predicted block information obtained by interpolating the intra basis block information
